(19) United States
(12) Patent Application Publication
(10) Pub. No.: US 2024/0371206 A1
(43) Pub. Date: Nov. 7, 2024

(54) CONFIRMATION SUPPORT DEVICE, CONFIRMATION SUPPORT METHOD, AND NON-TRANSITORY COMPUTER READABLE MEDIUM STORING PROGRAM

(71) Applicant: NEC Corporation, Minato-ku, Tokyo (JP)

(72) Inventor: Masato OGURA, Tokyo (JP)

(73) Assignee: NEC Corporation, Minato-ku, Tokyo (JP)

(21) Appl. No.: 18/285,696

(22) PCT Filed: Apr. 13, 2021
(86) PCT No.: PCT/JP2021/015265

§ 371 Date: Oct. 5, 2023

(51) Int. Cl. G06V 40/50; G06V 30/19

(52) U.S. Cl. CPC G06V 40/55; G06V 30/19013

(57) ABSTRACT

Provided is a confirmation support device, a confirmation support method, and a program that can support the work to visually check an image of an identification document to confirm a predetermined confirmation item. A confirmation support device (1) includes: a confirmation time acquisition unit (2) for acquiring a confirmation time, which is the time required for a first confirming person to visually check an image of an identification document to confirm a predetermined confirmation item; a risk level determination unit (3) for determining the risk level regarding the occurrence of a confirmation error by the first confirming person based on the confirmation time; and an alerting unit (4) for alerting a second confirming person based on the risk level when the second confirming person visually checks the image of the identification document to confirm the predetermined confirmation item.

### TECHNICAL FIELD

The present disclosure relates to a confirmation support device, a confirmation support method, and a non-transitory computer-readable medium storing a program.

### BACKGROUND ART

In recent years, electronic Know Your Customer (eKYC), which allows customers to complete identification procedures online, rather than having to go to a store counter in person or send documents by mail, is becoming increasingly popular. In this regard, for example, Patent Literature 1 discloses an information processing device operated by an identification service provider that provides ekYC services. The information processing device executes an online identification process in response to an identification request received from a user terminal. The use of ekYC provides various benefits, such as enabling users to complete identification procedures online, and enabling businesses to provide services to users more quickly because they no longer need to send documents by mail.

### CITATION LIST

### Patent Literature

Patent Literature 1: International Patent Publication No. WO 2020/246403

### SUMMARY OF INVENTION

### Technical Problem

However, in ekYC, laws and other regulations may require that information submitted online be visually confirmed by a confirming person. Thus, the intervention of human confirmation can lead to time-consuming confirmation and the possibility of human error. For this reason, there is a need to provide technology to support the work of visual confirmation by the confirming person.

Therefore, one of the objects to be achieved by the embodiments disclosed herein is to provide a confirmation support device, a confirmation support method, and a program that can support the work to confirm predetermined confirmation items by visually checking images of identification documents.

### Solution to Problem

A confirmation support device according to a first aspect of the present disclosure includes:

a confirmation time acquisition means for acquiring a confirmation time, which is the time required for a first confirming person to visually check an image of an identification document to confirm a predetermined confirmation item;

a risk level determination means for determining the risk level regarding the occurrence of a confirmation error by the first confirming person based on the confirmation time; and an alerting means for alerting a second confirming person based on the risk level when the second confirming person visually checks the image of the identification document to confirm the predetermined confirmation item.

A confirmation support method according to a second aspect of the present disclosure includes:
by a confirmation support device,
acquiring a confirmation time, which is the time required for a first confirming person to visually check an image of an identification document to confirm a predetermined confirmation item;
calculating a risk level regarding the occurrence of a confirmation error by the first confirming person based on the confirmation time; and
alerting a second confirming person based on the risk level when the second confirming person visually checks the image of the identification document to confirm the predetermined confirmation item.

A program according to a third aspect of the present disclosure causes a computer to execute:
a confirmation time acquisition step of acquiring a confirmation time, which is the time required for a first confirming person to visually check an image of an identification document to confirm a predetermined confirmation item;
a risk level determination step of determining the risk level regarding the occurrence of a confirmation error by the first confirming person based on the confirmation time; and
an alerting step of alerting a second confirming person based on the risk level when the second confirming person visually checks the image of the identification document to confirm the predetermined confirmation item.

### Advantageous Effects of Invention

According to the present disclosure, a confirmation support device, a confirmation support method, and a program can be provided that can support the work to confirm predetermined confirmation items by visually checking the images of identification documents.

### BRIEF DESCRIPTION OF DRAWINGS

FIG. 1 is a block diagram illustrating an example of a configuration of a confirmation support device according to an outline of an example embodiment.

FIG. 2 is a block diagram illustrating an example of a configuration of an authentication system.

FIG. 3 is a block diagram illustrating an example of a functional configuration of a KYC server.

FIG. 4 is a schematic diagram illustrating an example of a hardware configuration of a KYC server.

FIG. 5 is a flowchart illustrating an example of a flow of a process regarding identification.

FIG. 6 is a flowchart illustrating an example of a flow of confirmation by a confirming person.

FIG. 7 is a schematic diagram illustrating an example of a screen displayed on a confirming person terminal.

FIG. 8 is a schematic diagram illustrating an example of a screen displayed on a confirming person terminal.

FIG. 9 is a schematic diagram illustrating an example of a screen displayed on a confirming person terminal.

FIG. 10 is a schematic diagram illustrating an example of a screen displayed on a confirming person terminal.

FIG. 11 is a schematic diagram illustrating an example of a screen displayed on a confirming person terminal.

FIG. 12 is a schematic diagram illustrating an example of a screen displayed on a confirming person terminal.

FIG. 13 is a schematic diagram illustrating an example of a screen displayed on a confirming person terminal.

FIG. 14 is a schematic diagram illustrating an example of a screen displayed on a confirming person terminal.

### EXAMPLE EMBODIMENTS

### Outline of Example Embodiments

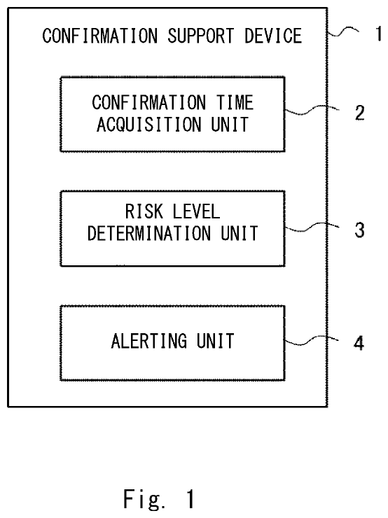

Before describing the details of an example embodiment, an outline of the example embodiment will be described. FIG. 1 is a block diagram illustrating an example of a configuration of a confirmation support device 1 according to an outline of the example embodiment. As illustrated in FIG. 1, the confirmation support device 1 includes a confirmation time acquisition unit 2, a risk level determination unit 3, and an alerting unit 4.

The confirmation time acquisition unit 2 acquires a confirmation time, which is the time required for a first confirming person to visually check an image of an identification document to confirm a predetermined confirmation item. Note that the acquired confirmation time is, for example, the confirmation time for each confirmation item, but may also be the time required to confirm all the confirmation items (total time).

The risk level determination unit 3 determines the risk level for occurrence of a confirmation error by the first confirming person based on the confirmation time acquired by the confirmation time acquisition unit 2. Note that, for example, in a case where the time acquired by the confirmation time acquisition unit 2 is the confirmation time for each confirmation item, the risk level determination unit 3 determines the risk level for each confirmation item, and when the time acquired by the confirmation time acquisition unit 2 is the total time, it determines the risk level collectively for all confirmation items. In addition to the confirmation time, the risk level determination unit 3 may also use the confirmation result (collation result) from the image recognition process to determine the risk level.

The alerting unit 4 alerts a second confirming person based on the risk level determined by the risk level determination unit 3 when the second confirming person visually checks the image of identification document, which has already been confirmed by the first confirming person, to confirm the predetermined confirmation item. Note that, for example, when the risk level determination unit 3 determines the risk level for each confirmation item, the alerting unit 4 alerts the second confirming person for each confirmation item based on the risk, and when the risk level determination unit 3 determines the risk level collectively for all confirmation items, the alerting unit 4 alerts the second confirming person in common for all confirmation items.

According to the confirmation support device 1, the risk level is determined based on the confirmation time by the first confirming person, and the second confirming person is alerted based on this risk level. That is, the confirmation support device 1 can alert the second confirming person according to the reliability of the confirmation by the first confirming person. Therefore, the second confirming person can perform the confirmation work with appropriate attention. This makes it possible to reduce the occurrence of human errors or to efficiently perform the confirmation by the second confirming person. Thus, the confirmation support device 1 can support the work to visually check an image of an identification document to confirm a predetermined confirmation item.

### Details of Example Embodiments

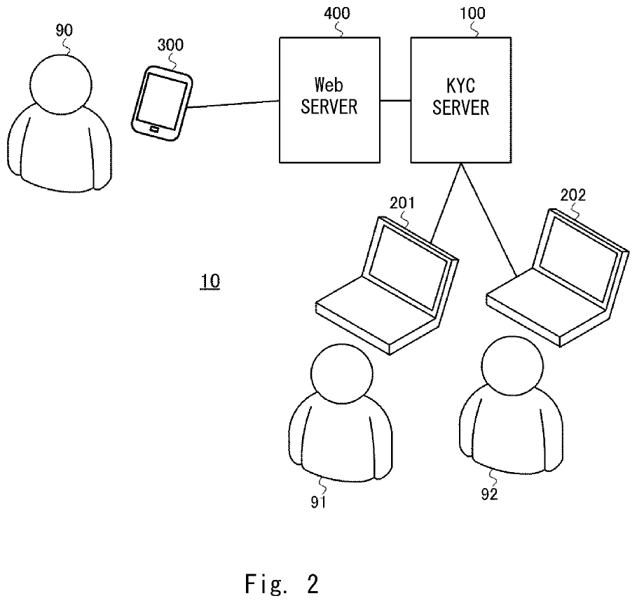

Next, details of the example embodiment will be described. FIG. 2 is a block diagram illustrating a configuration example of an authentication system 10 according to the example embodiment. As an example, the authentication system 10 illustrated in FIG. 2 includes a KYC server 100, confirming person terminals 201 and 202, an applicant terminal 300, and a Web server 400. Note that, in FIG. 2, in addition to the authentication system 10, an applicant 90 and confirming persons 91 and 92 are also illustrated to aid understanding. In the example illustrated in FIG. 2, one applicant terminal 300 is illustrated, but in a case where there is a plurality of applicants, there may be a plurality of applicant terminals 300. Furthermore, in the example illustrated in FIG. 2, two confirming person terminals 201 and 202 are illustrated for the confirming persons 91 and 92, but one confirming person terminal 201 may be used by the confirming persons 91 and 92.

The authentication system 10 is a system for performing identification of the applicant 90 (also referred to as an end user) through ekYC. The applicant 90 is, for example, a person who makes an application for opening a bank account, but the subject of the application is not limited to opening an account. Note that the applicant 90 is also referred to as a target person. The confirming persons 91 and 92 are responsible for confirming the information submitted by the applicant 90. The confirming persons 91 and 92 visually confirm the information transmitted from the applicant terminal 300. In the present example embodiment, after confirmation by the first confirming person 91, the second confirming person 92 confirms the same confirmation items that were confirmed by the confirming person 91. That is, the double checking is performed.

In the authentication system 10, the applicant terminal 300 and the Web server 400 are communicably connected via a wired or wireless network. The Web server 400 and the KYC server 100 are also communicably connected via a wired or wireless network. Furthermore, the KYC server 100 and the confirming person terminals 201 and 202 are also communicably connected via a wired or wireless network. Note that, if necessary, in addition to the connections described above, any other components may be communicably connected to each other.

The Web server 400 is a server that provides a Web page for accepting applications from the applicant 90. The Web server 400 acquires information necessary for performing identification from the applicant terminal 300 via the Web page. Specifically, the Web server 400 receives a character string about the personal information of the applicant 90 via the Web page. Here, the character string about the personal information of the applicant 90 specifically refers to, but is not limited to, a character string such as the name, address, date of birth, or contact address of the applicant 90. The Web server 400 also receives an image of the face of the applicant 90 via the Web page. In the present example embodiment, the Web server 400 receives an image obtained by photographing the front of the face of the applicant 90, and images of the face in response to predetermined instructions (instructions about facial orientation, facial expressions, etc.). The image of the face according to the predetermined instruction is an image for determining whether or not the person with the photographed face exists (so-called liveness determination), and specifically, is an image obtained by photographing the face from a predetermined direction or an image of the face with a predetermined facial expression. The character string about the personal information of the applicant 90 and the image of the face of the applicant 90 transmitted from the applicant terminal 300 are also referred to as target person data. Here, the target data may be defined as data about the target person created by the target person (applicant 90).

The Web server 400 also acquires the image of the identification document via the Web page. Here, the identification document is an optional document that identifies the applicant 90, and can also be referred to as an identification card. In the present example embodiment, as an example, the identification document is a driver's license with a face photograph, a name, a date of birth, and an address, but is not limited thereto, and may be any identification card including information necessary for identification. In the present example embodiment, since the identification is performed using the face image of the applicant 90 and the personal information of the applicant 90, the identification document preferably includes the applicant's face photograph and personal information. However, in a case where identification is performed using either the face image of the applicant 90 or personal information of the applicant 90, either the face photograph or the personal information should be included. The image of the identification document transmitted from the applicant terminal 300 may be referred to as certificate data. Here, the certificate data may be defined as data that is collated with the target person data to authenticate the target person data described above.

The Web server 400 transmits the information received from the applicant terminal 300, that is, the target person data and the certificate data described above, to the KYC server 100.

The applicant terminal 300 is a terminal device used by the applicant 90, and includes, for example, an input device such as a keyboard and an output device such as a display. The applicant terminal 300 may include a camera capable of photographing the face of the applicant 90. The applicant terminal 300 is, for example, a smartphone, a tablet terminal, a personal computer, or the like. The applicant terminal 300 accesses a Web page provided by the Web server 400 by the operation of the applicant 90 and transmits information necessary for performing identification. The applicant terminal 300 transmits the personal information of the applicant 90 and the face image of the applicant 90 to the Web server 400 according to the operation of the applicant 90. In the present example embodiment, for example, a name, an address, and a date of birth are transmitted as personal information, and an image obtained by photographing the front of the face and an image of the face according to a predetermined instruction are transmitted as the images of the face of the applicant 90. Further, the applicant terminal 300 transmits the image of the identification document according to the operation of the applicant 90. In the present example embodiment, for example, an image obtained by photographing the front side of an identification document, an image obtained by photographing the back side of the identification document, and an image obtained by photographing the identification document at an angle so that the thickness of the identification document can be recognized are transmitted as the images of the identification document.

The KYC server 100 corresponds to the confirmation support device 1 in FIG. 1, and is a server that supports identification for an application by the applicant 90. In the present example embodiment, the KYC server 100 acquires information necessary for performing identification via the Web server 400, but may acquire the information directly from the applicant terminal 300. In this case, the Web server 400 may be omitted. Furthermore, the Web server 400 may be included in the KYC server 100. Details of the KYC server 100 will be described later.

The confirming person terminals 201 and 202 are terminal devices used by the confirming persons 91 and 92, and include, for example, an input device such as a keyboard and an output device such as a display. The confirming person terminals 201 and 202 are, for example, a smartphone, a tablet terminal, a personal computer, or the like. The confirming persons 91 and 92 visually check the information necessary for identification transmitted from the applicant terminal 300, confirm predetermined confirmation items, and input confirmation results to the confirming person terminals 201 and 202. The confirming person terminals 201 and 202 transmit the input confirmation results to the KYC server 100. In particular, alert information determined according to the risk level determined based on the confirmation by the first confirming person 91 is transmitted to the confirming person terminal 202 used by the second confirming person 92. Therefore, the confirming person 92 confirms with reference to the alert information.

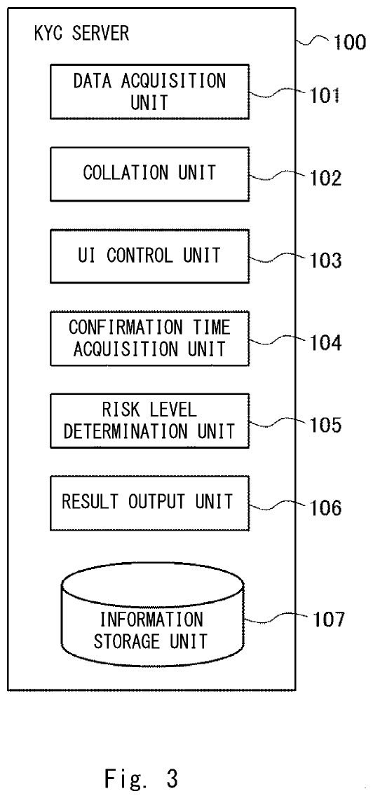

Next, the KYC server 100 will be described in detail. FIG. 3 is a block diagram illustrating an example of a functional configuration of the KYC server 100. As illustrated in FIG. 3, the KYC server 100 includes a data acquisition unit 101, a collation unit 102, a UI control unit 103, a confirmation time acquisition unit 104, a risk level determination unit 105, a result output unit 106, and an information storage unit 107.

The data acquisition unit 101 acquires target person data (that is, the character string about the personal information of the applicant 90 transmitted from the applicant terminal 300 and the face image of the applicant 90) and an image of an identification document. In the present example embodiment, the data acquisition unit 101 acquires these pieces of information from the Web server 400, but as described above, the data acquisition unit 101 may acquire the information directly from the applicant terminal 300. The data acquisition unit 101 stores the acquired information in the information storage unit 107.

The collation unit 102 compares and collates the target person data with the image of the identification document for the same applicant 90. The collation unit 102 performs an image recognition process to perform a collation process. For example, the collation unit 102 compares the character string of the personal information read from the image of the identification document by optical character recognition (OCR) with the character string of the personal information input by the operation by the applicant 90, and collates the two with each other. For example, the collation unit 102 collates the name read from the image of the identification document with the name acquired as the target person data. In this manner, the collation unit 102 compares the character string for each attribute of the personal information. In addition, the collation unit 102 compares the image of the face photograph included in the image of the identification document with the image of the face input by the operation by the applicant 90 by the face recognition process, and collates the two with each other. The collation unit 102 stores the collation result in the information storage unit 107. Specifically, the collation unit 102 calculates a match rate, and stores the calculated match rate in the information storage unit 107.

The user interface (UI) control unit 103 provides a user interface for the confirming person 91 to perform confirmation. The UI control unit 103 displays information (image or character string) to be confirmed on the confirming person terminals 201 and 202, and accepts input of the confirmation result. In particular, the UI control unit 103 transmits the information of the alert information determined according to the risk level determined based on the confirmation by the first confirming person 91 to the confirming person terminal 202 used by the second confirming person 92. For this purpose, the UI control unit 103 determines the alert information to be transmitted to the confirming person terminal 202 for each confirmation item according to the risk level for each confirmation item determined by the risk level determination unit 105 described later. In the present example embodiment, the UI control unit 103 controls that the alert information is displayed on the confirming person terminal 202, but the UI control unit 103 may also control that the alert information is output audibly at the confirming person terminal 202. As described above, in the present example embodiment, the UI control unit 103 alerts the second confirming person 92 based on the risk level. Therefore, the UI control unit 103 corresponds to the alerting unit 4 in FIG. 1. Note that a specific example of the screen provided by the UI control unit 103 will be described later.

The confirmation time acquisition unit 104 corresponds to the confirmation time acquisition unit 2 in FIG. 1. The confirmation time acquisition unit 104 acquires a confirmation time required for the first confirming person 91 to confirm a predetermined confirmation item for each confirmation item. For example, the confirmation time acquisition unit 104 acquires a confirmation time required for the first confirming person 91 to visually check the image of the identification document to confirm the predetermined confirmation item in order to determine whether or not the image of the identification document is appropriate. In addition, the confirmation time acquisition unit 104 may acquire the confirmation time required for the first confirming person 91 to confirm the predetermined confirmation item by visually comparing the image of the identification document and the target person data. In addition, the confirmation time acquisition unit 104 may acquire a confirmation time required to visually check the target person data (for example, a face image for liveness determination) to confirm a predetermined confirmation item in order to determine whether the target person data is appropriate.

Specifically, for example, the confirmation time acquisition unit 104 measures the time from the time the information to be confirmed is displayed on the confirming person terminal 201 by the UI control unit 103 to confirm a predetermined confirmation item until the confirmation result is transmitted from the confirming person terminal 201. Then, the confirmation time acquisition unit 104 acquires the measured time as the confirmation time for the confirmation item. The confirmation time acquisition unit 104 stores the acquired confirmation time in the information storage unit 107.

The risk level determination unit 105 corresponds to the risk level determination unit 3 in FIG. 1, and determines the risk level for occurrence of a confirmation error by the first confirming person 91 for each confirmation item based on the confirmation time for each confirmation item acquired by the confirmation time acquisition unit 104. This risk level is an index indicating how high the risk (possibility) of a confirmation error occurring in the confirmation by the first person. In other words, the risk level can also be said to be an index indicating the level of attention required in the confirmation by the second person. In the present example embodiment, the risk level determination unit 105 determines the risk level for the confirmation item for which the collation by the collation unit 102 has been obtained, based on the collation result by the collation unit 102 and the confirmation time acquired by the confirmation time acquisition unit 104. For example, the risk level determination unit 105 determines that the lower the match rate in the collation by the collation unit 102 and the shorter the confirmation time, the higher the risk (possibility) of occurrence of the confirmation error by the first confirming person 91. Furthermore, for example, the risk level determination unit 105 may determine the risk level as follows. The risk level determination unit 105 may determine that a predetermined alert to the second confirming person 92 is necessary when the match rate in the collation by the collation unit 102 is equal to or less than a predetermined reference value but the confirmation time is less than a predetermined time. In this case, the risk level determination unit 105 may determine that the shorter the confirmation time, the stronger alert is required. Note that the predetermined reference value and the predetermined time described above may be set by statistical analysis of past data by the risk level determination unit 105. For example, in a case where the match rate calculated by the collation unit 102 is 50% or less and the confirmation time is 5 seconds or less, a threshold value for determining the risk level may be set using statistical data, such as 80% probability that double-checking will correct a confirmed result. In addition, the risk level determination unit 105 determines the risk level for a confirmation item for which collation by the collation unit 102 has not been obtained based the confirmation time acquired by the confirmation time acquisition unit 104. For example, in this case, the risk level determination unit 105 determines that the shorter the confirmation time, the higher the risk (possibility) that a confirmation error by the first confirming person 91 has occurred. Note that, also for a confirmation item for which no collation has been obtained by the collation unit 102, the risk level determination unit 105 may determine whether or not a predetermined alert to the second confirming person 92 is necessary using a threshold value using statistical data as described above.

The result output unit 106 outputs a result of identification (authentication result) of the applicant 90 (target person). The result output unit 106 outputs the result to any device. For example, the result output unit 106 may output the result to the confirming person terminals 201 and 202, may transmit the result to the applicant terminal 300, or may transmit the result to the Web server 400. Note that the result output unit 106 may output the result to a device other than these devices.

Here, in the present example embodiment, when the result of collation of the target person data with the image of the identification document by the collation unit 102 does not satisfy the predetermined criterion, the result output unit 106 outputs the result of the identification according to the confirmation result by the first confirming person 91 and the second confirming person 92. On the other hand, when the collation result of the target person data with the image of the identification document by the collation unit 102 satisfies a predetermined criterion, the result output unit 106 outputs the result of identification according to the collation result. That is, in this case, the result of the identification is output without undergoing the confirmation by the confirming persons 91 and 92. That is, in this case, the confirmation work of the confirming persons 91 and 92 can be omitted. This can reduce the cost of human confirmation work. Here, the case where the collation result satisfies the predetermined criterion may be specifically a case where the match rate calculated by the collation unit 102 is equal to or greater than a predetermined pass threshold value, or may be a case where the match ate calculated by the collation unit 102 is less than a predetermined fail threshold value. For example, when the match rate calculated by the collation unit 102 is equal to or greater than a predetermined pass threshold value, the result output unit 106 outputs a result indicating that the identification is successful. Furthermore, for example, in a case where the match rate calculated by the collation unit 102 is less than a predetermined failure threshold value, the result output unit 106 outputs a result indicating that the identification has failed. Note that these threshold values may be set using statistical data regarding past identification.

The information storage unit 107 stores the information (the target person data and the image of the identification document) acquired by the data acquisition unit 101, the collation result by the collation unit 102, the confirmation time acquired by the confirmation time acquisition unit 104, and the like. Note that the information storage unit 107 stores these pieces of information for the same applicant 90 in association with each other. The stored information is referred to for processing by each component of the KYC server 100. In addition, the information storage unit 107 may store statistical data used to set the threshold value described above.

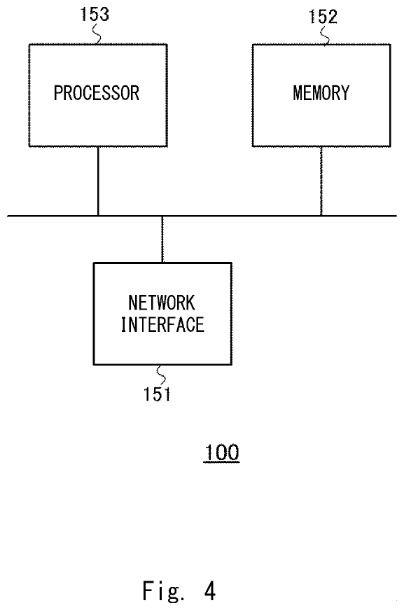

Next, a hardware configuration of the KYC server 100 will be described. FIG. 4 is a schematic diagram illustrating an example of a hardware configuration of the KYC server 100. As illustrated in FIG. 4, the KYC server 100 includes a network interface 151, a memory 152, and a processor 153.

The network interface 151 is used to communicate with any other device. The network interface 151 may include, for example, a network interface card (NIC).

The memory 152 includes, for example, a combination of a volatile memory and a nonvolatile memory. The memory 152 is used to store programs including one or more instructions executed by the processor 153, data used for various processes of the KYC server 100, and the like. The information storage unit 107 may be implemented by the memory 152 or by any other storage.

The processor 153 reads a program from the memory 152 and executes the program to perform the process of each component illustrated in FIG. 3. The processor 153 may be, for example, a microprocessor, a micro processor unit (MPU), or a central processing unit (CPU). The processor 153 may include a plurality of processors.

As described above, the KYC server 100 has a function as a computer. The applicant terminal 300, the Web server 400, and the confirming person terminals 201 and 202 may similarly include a processor and a memory and have a function of a computer. Therefore, the functions of these devices may be implemented by execution of a program by a processor.

The program also includes a group of instructions (or software code) for causing a computer to perform one or more functions described in the example embodiment when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals.

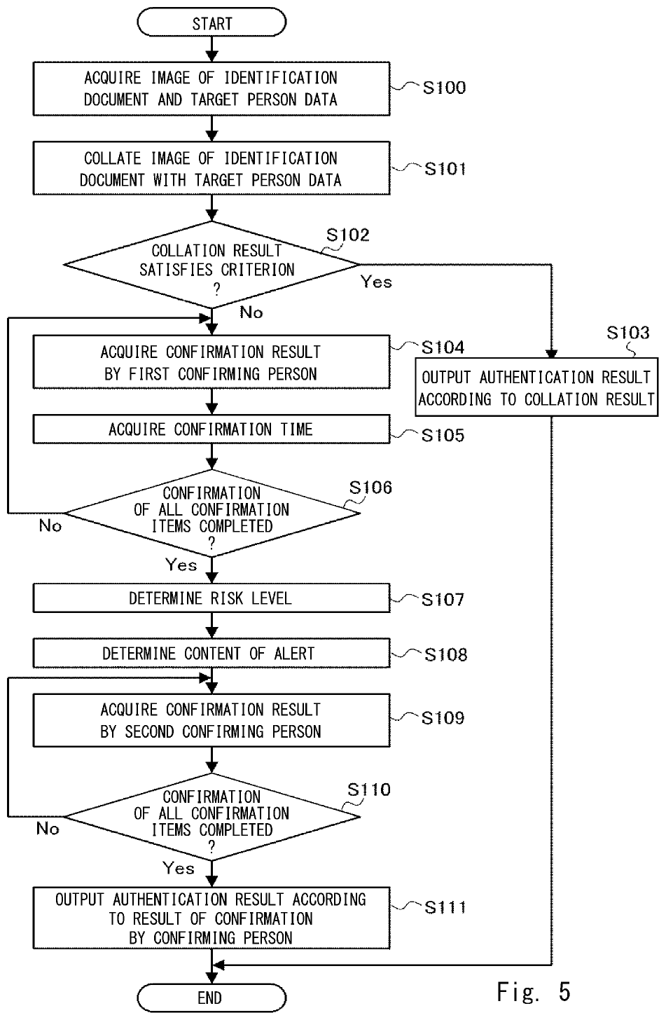

Next, the flow of the process related to identification in the present example embodiment will be described. FIG. 5 is a flowchart illustrating an example of a flow of a process regarding identification. Note that the flow of the flowchart illustrated in FIG. 5 is merely an example, and the order of each step is not limited to the order illustrated in FIG. 5 and may be changed. Hereinafter, the process flow will be described with reference to FIG. 5.

In step S100, the data acquisition unit 101 acquires target person data (that is, the character string for the personal information of the applicant 90 transmitted from the applicant terminal 300 and the face mage of the applicant 90) and an image of an identification document.

Next, in step S101, the collation unit 102 compares and collates the target person data acquired in step S100 with the image of the identification document.

Next, in step S102, the collation unit 102 determines whether or not the collation result in step S101 satisfies a predetermined criterion. When the collation result satisfies the predetermined criterion, the process proceeds to step S103. Then, in step S103, the result output unit 106 outputs a result of identification according to the collation result. Then, the identification process for the applicant 90 to be determined ends. In this case, the confirmation by the first confirming person 91 and the second confirming person 92 is omitted. On the other hand, when the collation result does not satisfy the predetermined criterion, the process proceeds to step S104 in order to acquire the confirmation results by the first confirming person 91 and the second confirming person 92.

In step S104, the UI control unit 103 displays the information to be confirmed on the confirming person terminal 201 and accepts input of the confirmation result. As a result, the UI control unit 103 acquires the confirmation result by the first confirming person 91.

Next, in step S105, the confirmation time acquisition unit 104 acquires the confirmation time for the confirmation by the first confirming person 91 performed in step S104.

Next, in step S106, the UI control unit 103 determines whether or not the confirmation by the first confirming person 91 has been completed for all the confirmation items. In a case where there is a confirmation item that has not been confirmed, the process returns to step S104, and a confirmation result for the confirmation item that has not been confirmed is acquired. Then, in step S105, a confirmation time for this confirmation item is acquired. When the confirmation by the first confirming person 91 has been completed for all the confirmation items, the process proceeds to step S107.

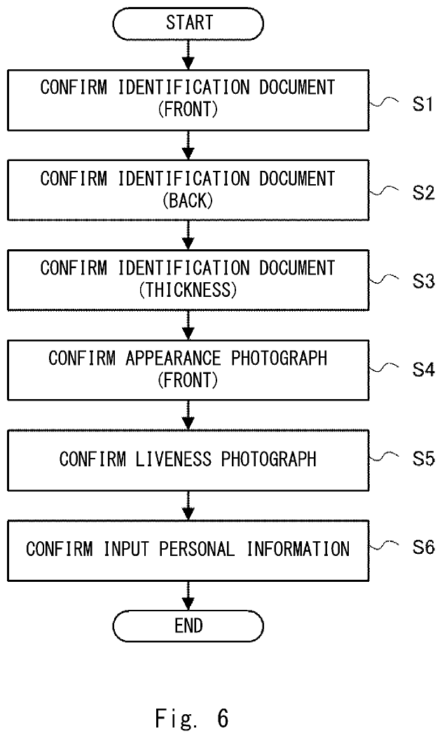

Here, the flow of confirmation by the confirming persons 91 and 92 in the present example embodiment will be described. FIG. 6 is a flowchart illustrating an example of a flow of confirmation by the confirming persons 91 and 92. Each step illustrated in FIG. 6 corresponds to each confirmation item. That is, in the present example embodiment, as an example, six confirmation items are confirmed as illustrated in FIG. 6.

In the present example embodiment, first, in step S1, the confirming persons 91 and 92 visually confirm the front side of the identification document. That is, the confirmation item in step S1 is confirmation as to whether the front side of the identification document is appropriate. This confirmation is performed by visually checking the image on the front side of the identification document. The confirming persons 91 and 92 visually confirm predetermined various points to confirm whether the front side of the identification document is appropriate. The various points include, for example, whether it is stamped with an official seal, whether it has not expired, and the like.

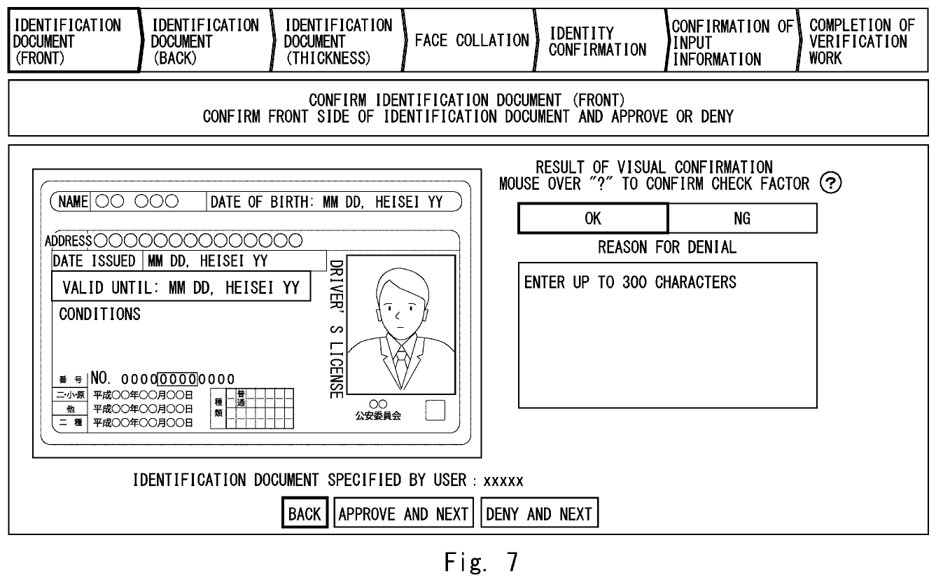

In response to the confirmation item in step S1, in step S104 of the flowchart in FIG. 5, the UI control unit 103 controls the confirming person terminal 201 to display a screen as illustrated in FIG. 7, for example. The confirming person 91 visually checks such a screen and inputs the result of confirmation. At this time, the time taken for the confirmation is acquired in step S105.

Next, in step S2, the confirming persons 91 and 92 visually confirm the back side of the identification document. That is, the confirmation item in step S2 is confirmation as to whether or not the back side of the identification document is appropriate. This confirmation is performed by visually checking the back side image of the identification document. The confirming persons 91 and 92 visually confirm predetermined various points to confirm whether the back side of the identification document is appropriate.

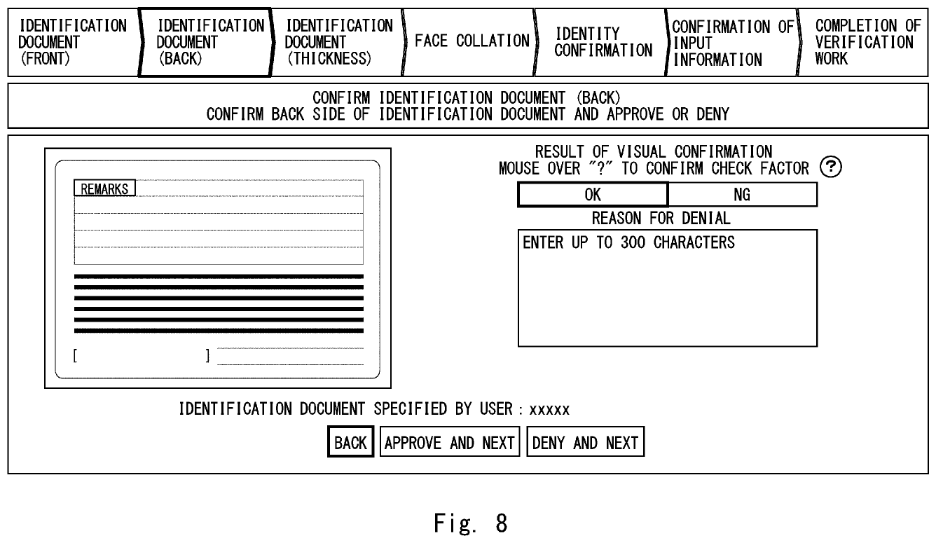

In response to the confirmation item in step S2, in step S104 of the flowchart in FIG. 5, the UI control unit 103 controls the confirming person terminal 201 to display a screen as illustrated in FIG. 8, for example. The confirming person 91 visually checks such a screen and inputs the result of confirmation. At this time, the time taken for the confirmation is acquired in step S105.

Next, in step S3, the confirming person 91 and the confirming person 92 visually confirm the thickness of the identification document. That is, the confirmation item in step S3 is confirmation as to whether the thickness of the identification document is appropriate. This confirmation is performed by visually checking an image taken with the identification document tilted. The confirming persons 91 and 92 visually confirm predetermined various points to confirm whether the thickness of the identification document is appropriate.

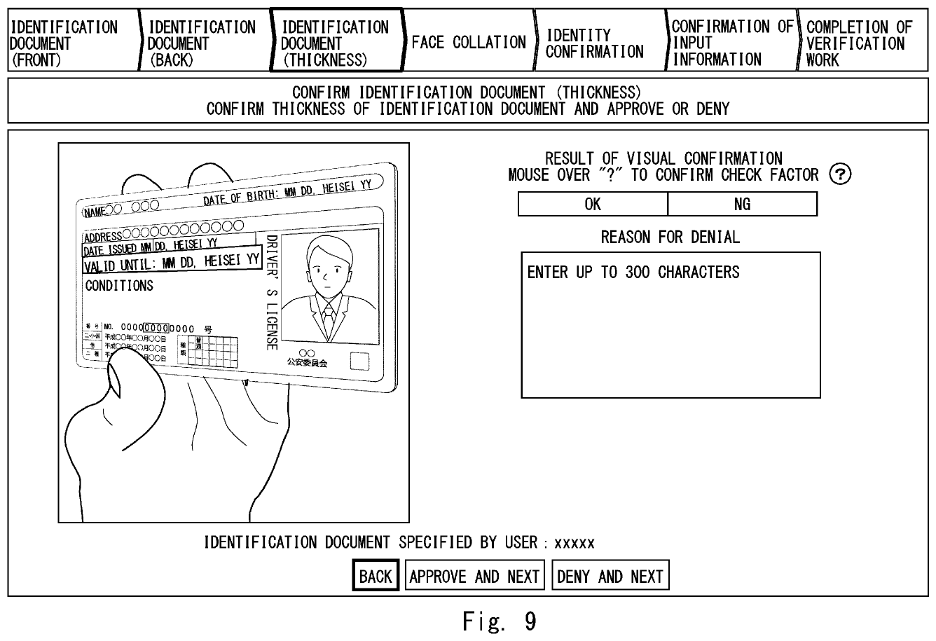

In response to the confirmation item in step S3, in step S104 of the flowchart in FIG. 5, the UI control unit 103 controls the confirming person terminal 201 to display a screen as illustrated in FIG. 9, for example. The confirming person 91 visually checks such a screen and inputs the result of confirmation. At this time, the time taken for the confirmation is acquired in step S105.

Next, in step S4, the confirming persons 91 and 92 visually confirm the appearance photograph of the applicant 90. That is, the confirmation item in step S4 is to confirm whether or not the image obtained by photographing the front of the face submitted by the applicant 90 is appropriate. This confirmation is performed by visually checking the image obtained by photographing the front of the face submitted by the applicant 90 and an image of a face photograph in the identification document. The confirming persons 91 and 92 visually confirm predetermined various points to confirm whether or not the image obtained by photographing the front of the face submitted by the applicant 90 is appropriate. In particular, the confirming persons 91 and 92 confirm whether the person in the image obtained by photographing the front of the face submitted by the applicant 90 and the person in the face photograph in the identification document are the same person.

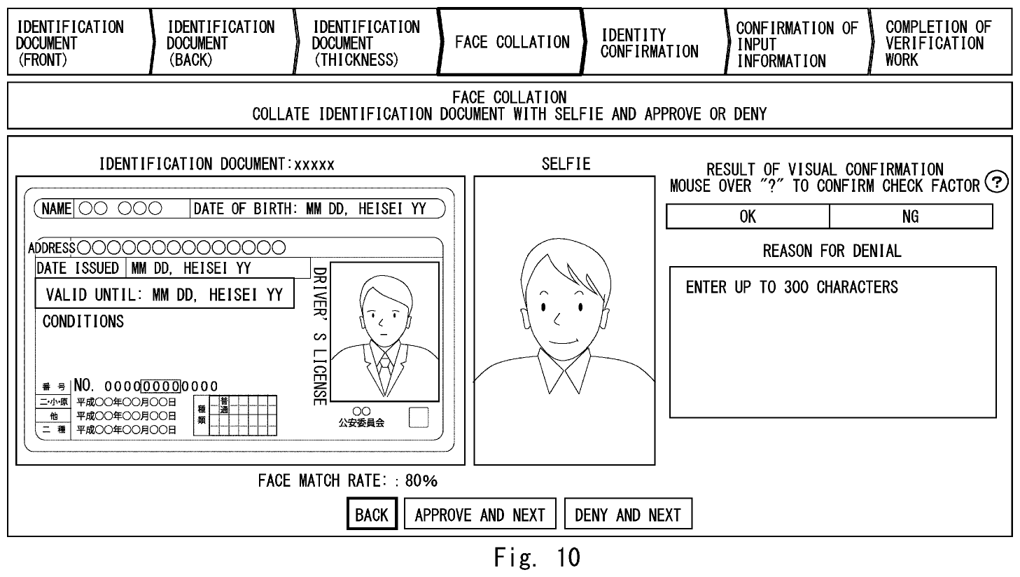

In response to the confirmation item in step S4, in step S104 of the flowchart in FIG. 5, the UI control unit 103 controls the confirming person terminal 201 to display a screen as illustrated in FIG. 10, for example. Note that, as illustrated in FIG. 10, the UI control unit 103 may display on the screen the collation result by the collation unit 102, that is, the match rate between the face of the image submitted by the applicant 90 and the face included in the identification document. That is, the confirming person 91 may confirm with reference to the displayed match rate. The confirming person 91 visually checks such a screen and inputs the result of confirmation. At this time, the time taken for the confirmation is acquired in step S105. Note that the acquired confirmation time and the collation result by the collation unit 102 are stored in the information storage unit 107 in association with each other.

Next, in step S5, the confirming persons 91 and 92 visually confirm the liveness photograph (photograph for liveness determination) of the applicant 90. That is, the confirmation item in step S5 is to confirm whether or not the face image submitted by the applicant 90 for liveness determination is appropriate. This confirmation is performed by visually checking the face image submitted by the applicant 90 for liveness determination, that is, the face image according to a predetermined instruction. The confirming persons 91 and 92 visually confirm predetermined various points to confirm whether or not the face image submitted by the applicant 90 for liveness determination is appropriate. In particular, the confirming persons 91 and 92 check whether or not a person in the image obtained by photographing the front of the face submitted by the applicant 90 and a person in the face image for liveness determination are the same person. In addition, the confirming persons 91 and 92 confirm whether or not an image that satisfies an instruction regarding the facial orientation or the facial expression has been submitted.

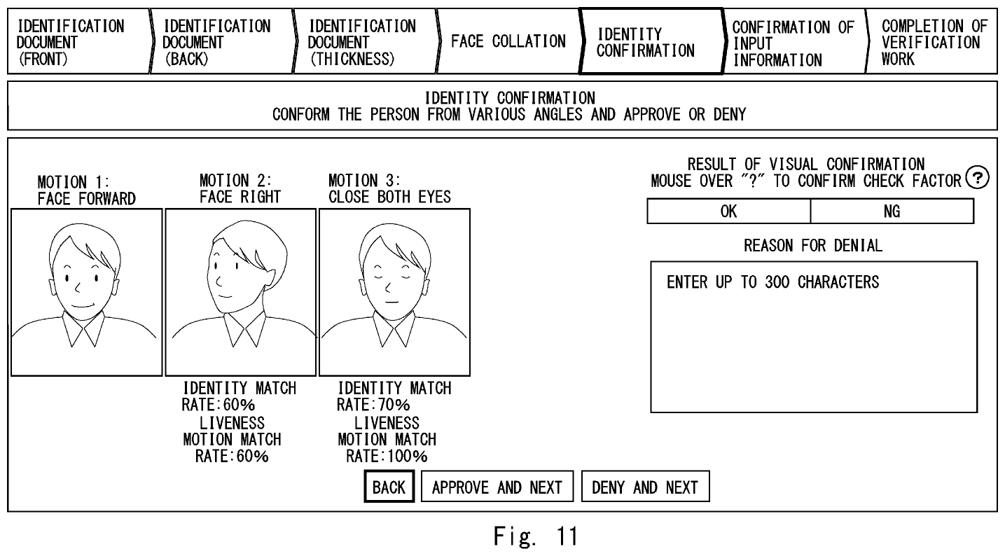

In response to the confirmation item in step S5, in step S104 of the flowchart in FIG. 5, the UI control unit 103 controls the confirming person terminal 201 to display a screen as illustrated in FIG. 11, for example. Note that, as illustrated in FIG. 11, the UI control unit 103 may display on the screen the collation result by the collation unit 102, that is, the match rate between the face of the image submitted by the applicant 90 and the face included in the identification document. In addition, the collation unit 102 may determine whether or not the face image for liveness determination matches the instruction, and the UI control unit 103 may display on the screen a match rate indicating how much the face image for the liveness determination satisfies the instruction, as illustrated in FIG. 11. In this manner, the confirming person 91 may confirm with reference to the displayed match rate. The confirming person 91 visually checks such a screen and inputs the result of confirmation. At this time, the time taken for the confirmation is acquired in step S105. Note that the acquired confirmation time and the collation result by the collation unit 102 are stored in the information storage unit 107 in association with each other.

Next, in step S6, the confirming persons 91 and 92 visually confirm the personal information of the applicant 90. That is, the confirmation item in step S6 is to confirm whether or not the personal information submitted by the applicant 90 is appropriate. This confirmation is performed by visually checking the character string about the personal information input by the applicant 90 and the character string about the personal information in the identification document. The confirming persons 91 and 92 visually confirm predetermined various points to confirm whether or not the personal information submitted by the applicant 90 is appropriate. For example, the confirming persons 91 and 92 confirm whether the character string about the personal information submitted by the applicant 90 matches the character string extracted from the identification document by OCR.

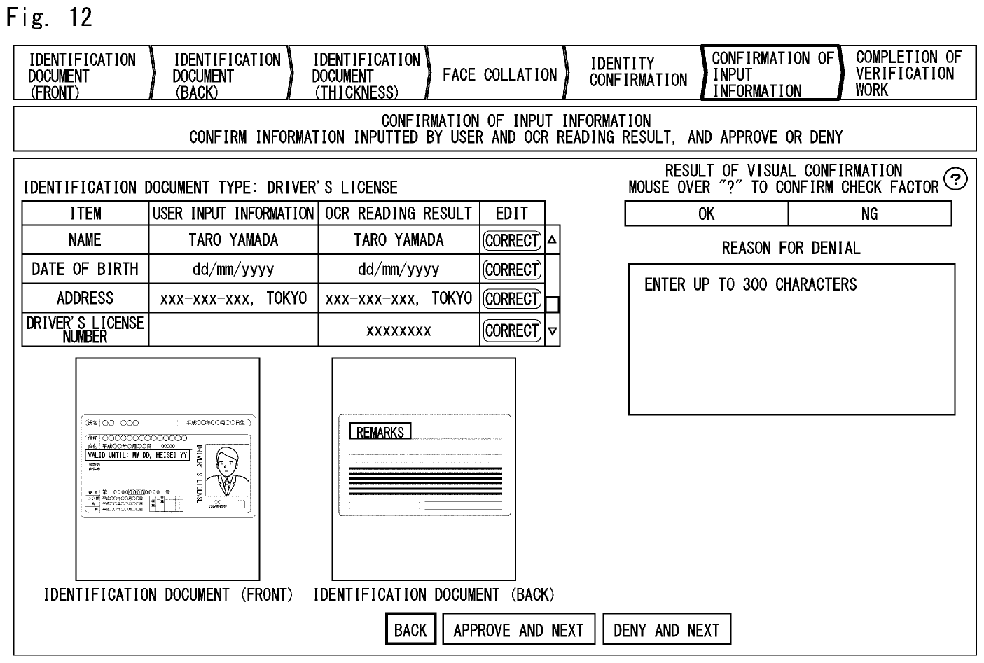

In response to the confirmation item in step S6, in step S104 of the flowchart in FIG. 5, the UI control unit 103 controls the confirming person terminal 201 to display a screen as illustrated in FIG. 12, for example. In the example illustrated in FIG. 12, the UI control unit 103 displays on the screen a table that lists, by attribute, a character string about the personal information input by the applicant 90 and a character string about the personal information read from the identification document by OCR, and an image of the identification document. Note that the UI control unit 103 may display on the screen the collation result of the character string about the personal information by the collation unit 102, that is, the match rate between the character string about the input personal information and the character string about the personal information read by OCR from the identification document. In this manner, the confirming person 91 may confirm with reference to the displayed match rate. The confirming person 91 visually checks such a screen and inputs the result of confirmation. At this time, the time taken for the confirmation is acquired in step S105. Note that the acquired confirmation time and the collation result by the collation unit 102 are stored in the information storage unit 107 in association with each other.

As described above, in the present example embodiment, a plurality of confirmation items is confirmed in order, and the confirmation time at that time is acquired for each confirmation item. Note that the flow of the flowchart illustrated in FIG. 6 is merely an example, and the order of each step is not limited to the order illustrated in FIG. 6 and may be changed.

Returning to the flowchart in FIG. 5, the operations after step S107 will be described.

In step S107, the risk level determination unit 105 determines a risk level for occurrence of a confirmation error by the first confirming person 91 for each confirmation item. For example, for the confirmation items in steps S1, S2, and S3 in FIG. 6, the risk level determination unit 105 determines the risk level based on the confirmation time acquired by the confirmation time acquisition unit 104. In addition, the risk level determination unit 105 determines the risk level for each of the confirmation items in steps S4, S5, and S6 in FIG. 6 based on the confirmation time acquired by the confirmation time acquisition unit 104 and the collation result of the collation unit 102. Note that, in the example illustrated in FIG. 5, although the risk level determination unit 105 determines the risk level of each confirmation item after the first confirming person 91 finishes confirming all the confirmation items, it may also determine the risk level of the confirmation item each time the confirmation of one confirmation item is finished.

Next, in step S108, the UI control unit 103 determines the content of the alert for the second confirming person 92 for each confirmation item according to the risk level for each confirmation item determined by the risk level determination unit 105. For example, the UI control unit 103 determines the content of the alert such that the higher the risk level, the stronger the alert is provided to the confirming person 92.

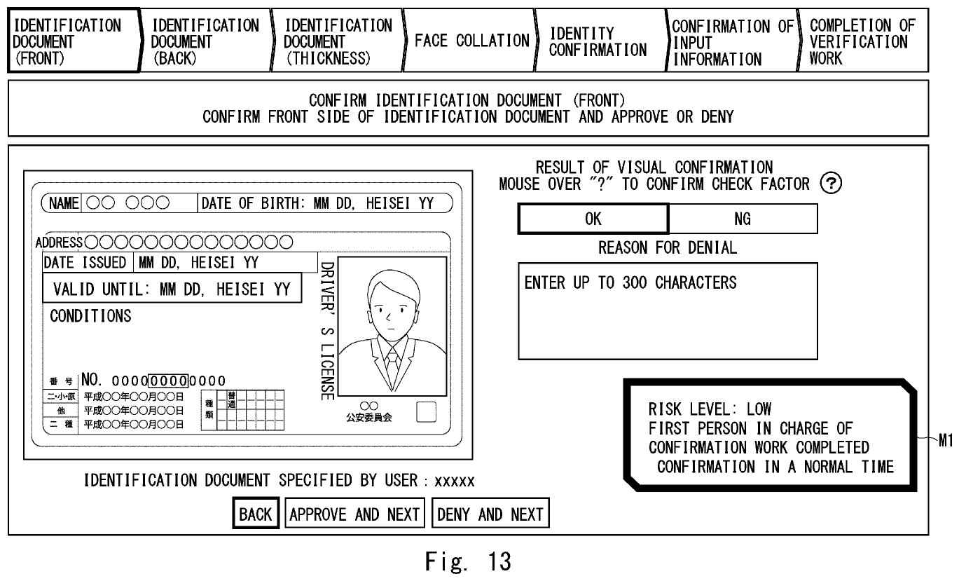

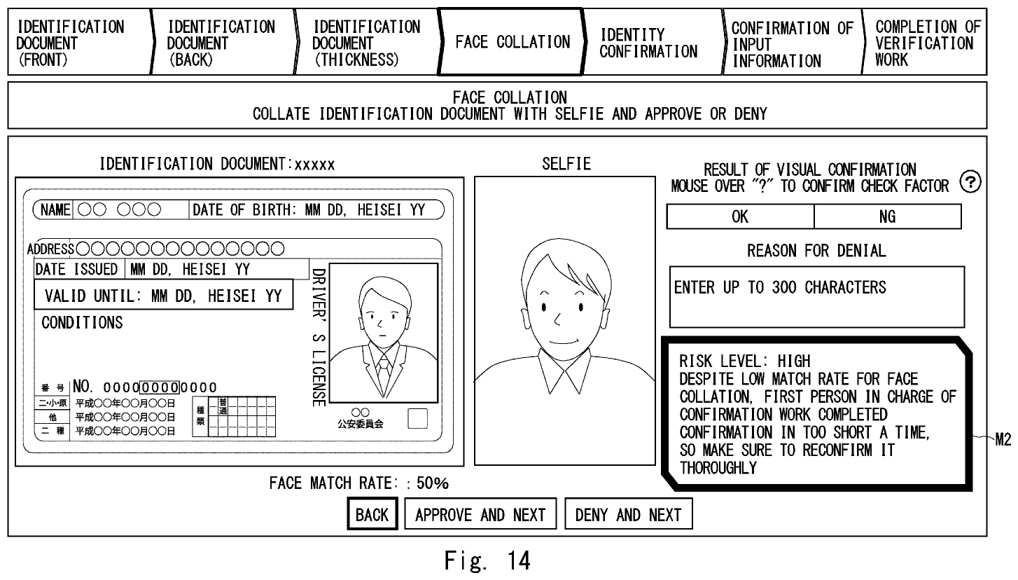

Next, in step S109, the UI control unit 103 acquires the confirmation result by the second confirming person 92. Note that, prior to this, the UI control unit 103 may output a notification for requesting confirmation by the second confirming person 92. In order to acquire the confirmation result by the second person, the UI control unit 103 performs control so that a screen similar to the screen displayed when acquiring the confirmation result by the first confirming person 91 is displayed on the confirming person terminal 202. However, the UI control unit 103 further displays the content of the alert determined in step S108 on the screen of each confirmation item for the second confirming person 92. For example, the UI control unit 103 displays the screen illustrated in FIG. 13, the screen illustrated in FIG. 14, and the like according to the determined risk level. Note that FIG. 13 is a screen example in a case where the risk level is low, and a message M1 is displayed as an alert message. FIG. 14 is a screen example in a case where the risk level is high, and a message M2 is displayed as an alert message.

After step S109, the process returns to step S110.

Next, in step S110, the UI control unit 103 determines whether or not the confirmation by the second confirming person 92 has been completed for all the confirmation items. In a case where there is a confirmation item that has not been confirmed, the process returns to step S109, and a confirmation result for the confirmation item that has not been confirmed is acquired. In a case where the confirmation by the second confirming person 92 has been completed for all the confirmation items, that is, in a case where the confirmation has been completed for the six confirmation items illustrated in FIG. 6, the process proceeds to step S111.

In step S111, the result output unit 106 outputs a result of identification according to the confirmation results by the first confirming person 91 and the second confirming person 92. For example, the result output unit 106 outputs a result indicating that the identification has succeeded when the first confirming person 91 and the second confirming person 92 determine that all the confirmation items are appropriate, and outputs a result indicating that the identification has failed in other cases. Note that the result indicating that the identification failed may indicate the confirmation items that were determined to be inappropriate, or may indicate the reason why the identification was determined to be inappropriate.

As described above, in the present example embodiment, when the second confirming person 92 confirms, an alert is given based on the determined risk level. Therefore, the second confirming person 92 can perform the confirmation work with appropriate attention. This makes it possible to reduce the occurrence of human errors or to efficiently perform the confirmation by the second confirming person 92. Furthermore, in the present example embodiment, in a case where the collation result by the collation unit 102 satisfies a predetermined criterion, the identification result can be obtained without confirmation by the confirming persons 91 and 92. Therefore, the cost of the confirmation work can be reduced.

Although the present invention has been described above with reference to the example embodiments, the present invention is not limited to the above. Various modifications that can be understood by those skilled in the art can be made to the configuration and details of the present invention within the scope of the present invention.

Some or all of the above-described example embodiments may be described as the following supplementary notes, but are not limited to the following.
(Supplementary Note 1)
   A confirmation support device including:
   a confirmation time acquisition means for acquiring a confirmation time, which is the time required for a first confirming person to visually check an image of an identification document to confirm a predetermined confirmation item;
   a risk level determination means for determining the risk level regarding the occurrence of a confirmation error by the first confirming person based on the confirmation time; and an alerting means for alerting a second confirming person based on the risk level when the second confirming person visually checks the image of the identification document to confirm the predetermined confirmation item.
(Supplementary Note 2)
   The confirmation support device according to Supplementary Note 1, further including:
   a data acquisition means for acquiring target person data, which is data about a target person created by the target person, and an image of the identification document; and
   a collation means for comparing the target person data with the image of the identification document for collation,
   in which the confirmation time acquisition means is configured to acquire the confirmation time required for the first confirming person to confirm the predetermined confirmation item by visually comparing the image of the identification document and the target person data, and
   the risk level determination means is configured to determine the risk level based on the confirmation time and the result of collation of the target person data with the image of the identification document.
(Supplementary Note 3)
   The confirmation support device according to Supplementary Note 2, further including a result output means for outputting the result of the identification of the target person,
   in which the result output means is configured to output the result of identification of the target person according to the result of the collation of the target person data with the image of the identification document when the result of the collation of the target person data with the image of the identification document satisfies a predetermined criterion, and outputs the result of identification of the target person according to the confirmation result by the first and second confirming persons when the result of collation of the target person data with the image of the identification document does not satisfy the predetermined criterion.
(Supplementary Note 4)
   The confirmation support device according to any one of Supplementary Notes 1 to 3,
   in which the confirmation time acquisition means is configured to acquire the confirmation time for each of the predetermined confirmation items,
   the risk level determination means is configured to calculate the risk level for each of the predetermined confirmation items, and
   the alerting means is configured to alert the second confirming person for each of the predetermined confirmation items based on the risk level.
(Supplementary Note 5)
   The confirmation support device according to Supplementary Note 2 or 3, in which the target person data includes a face image of the target person.
(Supplementary Note 6)
   The confirmation support device according to Supplementary Note 2 or 3, in which the target person data includes a character string regarding personal information of the target person.
(Supplementary Note 7)
   A confirmation support method including:
   by a confirmation support device, acquiring a confirmation time, which is the time required for a first confirming person to visually check an image of an identification document to confirm a predetermined confirmation item;
   calculating a risk level regarding the occurrence of a confirmation error by the first confirming person based on the confirmation time; and
   alerting a second confirming person based on the risk level when the second confirming person visually checks the image of the identification document to confirm the predetermined confirmation item.
(Supplementary Note 8)
   A non-transitory computer-readable medium storing a program for causing a computer to execute:
   a confirmation time acquisition step of acquiring a confirmation time, which is the time required for a first confirming person to visually check an image of an identification document to confirm a predetermined confirmation item;
   a risk level determination step of determining the risk level regarding the occurrence of a confirmation error by the first confirming person based on the confirmation time; and
   an alerting step of alerting a second confirming person based on the risk level when the second confirming person visually checks the image of the identification document to confirm the predetermined confirmation item.

### REFERENCE SIGNS LIST

1 CONFIRMATION SUPPORT DEVICE
2 CONFIRMATION TIME ACQUISITION UNIT
3 RISK LEVEL DETERMINATION UNIT
4 ALERTING UNIT
10 AUTHENTICATION SYSTEM
90 APPLICANT
91 CONFIRMING PERSON
92 CONFIRMING PERSON
100 KYC SERVER
101 DATA ACQUISITION UNIT
102 COLLATION UNIT
103 UI CONTROL UNIT
104 CONFIRMATION TIME ACQUISITION UNIT
105 RISK LEVEL DETERMINATION UNIT
106 RESULT OUTPUT UNIT
107 INFORMATION STORAGE UNIT
151 NETWORK INTERFACE
152 MEMORY
153 PROCESSOR
201 CONFIRMING PERSON TERMINAL
202 CONFIRMING PERSON TERMINAL
300 APPLICANT TERMINAL
400 WEB SERVER

What is claimed is:

1. A confirmation support device comprising:
at least one memory storing instructions; and
at least one processor configured to execute the instructions to:
acquire a confirmation time, which is the time required for a first confirming person to visually check an image of an identification document to confirm a predetermined confirmation item;
determine the risk level regarding the occurrence of a confirmation error by the first confirming person based on the confirmation time; and
alert a second confirming person based on the risk level when the second confirming person visually checks the image of the identification document to confirm the predetermined confirmation item.

2. The confirmation support device according to claim 1, wherein the processor is further configured to execute the instructions to:
acquire target person data, which is data about a target person created by the target person, and an image of the identification document;
compare the target person data with the image of the identification document for collation; collation,
acquire the confirmation time required for the first confirming person to confirm the predetermined confirmation item by visually comparing the image of the identification document and the target person data; and
determine the risk level based on the confirmation time and the result of collation of the target person data with the image of the identification document.

3. The confirmation support device according to claim 2,
wherein the processor is further configured to execute the instructions to output the result of identification of the target person according to the result of the collation of the target person data with the image of the identification document when the result of the collation of the target person data with the image of the identification document satisfies a predetermined criterion, and output the result of identification of the target person according to the confirmation result by the first and second confirming persons when the result of collation of the target person data with the image of the identification document does not satisfy the predetermined criterion.

4. The confirmation support device according to claim 1, wherein the processor is further configured to execute the instructions to:
acquire the confirmation time for each of the predetermined confirmation items,
calculate the risk level for each of the predetermined confirmation items, and
alert the second confirming person for each of the predetermined confirmation items based on the risk level.

5. The confirmation support device according to claim 2, wherein the target person data comprises a face image of the target person.

6. The confirmation support device according to claim 2, wherein the target person data comprises a character string regarding personal information of the target person.

7. A confirmation support method comprising:
by a confirmation support device,
acquiring a confirmation time, which is the time required for a first confirming person to visually check an image of an identification document to confirm a predetermined confirmation item;
calculating a risk level regarding the occurrence of a confirmation error by the first confirming person based on the confirmation time; and
alerting a second confirming person based on the risk level when the second confirming person visually checks the image of the identification document to confirm the predetermined confirmation item.

8. A non-transitory computer-readable medium storing a program for causing a computer to execute:
a confirmation time acquisition step of acquiring a confirmation time, which is the time required for a first confirming person to visually check an image of an identification document to confirm a predetermined confirmation item;
a risk level determination step of determining the risk level regarding the occurrence of a confirmation error by the first confirming person based on the confirmation time; and
an alerting step of alerting a second confirming person based on the risk level when the second confirming person visually checks the image of the identification document to confirm the predetermined confirmation item.
